(19) United States
(12) Patent Application Publication
(10) Pub. No.: US 2013/0343863 A1
(43) Pub. Date: Dec. 26, 2013

(54) MULTIFUNCTIONAL TRUCK TAILGATE LADDER

(71) Applicant: William J. Nemeth, Victor, ID (US)

(72) Inventor: William J. Nemeth, Victor, ID (US)

(21) Appl. No.: 13/924,030

(22) Filed: Jun. 21, 2013

Related U.S. Application Data
(60) Provisional application No. 61/784,485, filed on Mar. 14, 2013.
(60) Provisional application No. 61/662,623, filed on Jun. 21, 2012.

(51) Int. Cl. E06C 5/04

(52) U.S. Cl. CPC E06C 5/04
USPC 414/809; 182/129

(57) ABSTRACT

An automotive ladder and mounting assembly for use to access automotive compartments such as a truck bed or a horizontal deck is disclosed. The ladder can have a variety of features including extendable legs or wheels and a dolly platform for transporting items and may be detachable from the automobiles for use as a ladder or hand truck.

### TECHNICAL FIELD OF THE INVENTION

The present invention relates to automotive ladders, including multi-function ladders useful for accessing an automotive bay such as a cargo bay or truck bed.

### BACKGROUND

Users of trucks and similar automobiles often carry cargo such as equipment, tools, and supplies. Easy access to and from the cargo area is desirable both for a person's convenience and safety. Some automobiles, including trucks, typically have a tailgate that can be opened to help access the cargo bed, however, even when open to the horizontal position, the tailgate is frequently too high off the ground to afford the convenience and safety desired by a user. In addition, equipment such as a dolly or hand cart to ferry equipment from the vehicle to a desired location would be useful if it can be easily stored or mounted on the vehicle and easy to use.

While attempts to improve egress from cargo areas of vehicles have been made, there remains a need for improved access, particularly with equipment that can also be used for transporting cargo from the vehicle. For example, some ladders are formed as part of the tailgate, and thus cannot be removed from the tailgate or retrofit onto existing tailgates. Other conventional tailgate ladders are fixed to the inside of the tailgate. Some tailgate ladders are foldable with multiple pivot points which increase manufacturing cost. There is, therefore, a need for truck tailgate ladders that can be securely attached to any horizontal deck surface but still provide versatile and convenient use and be economical to manufacture.

### SUMMARY

In one aspect, a multi-function automotive ladder is disclosed having a frame having two stringers, each stringer having upper and lower ends; a plurality of steps extending between the stringers; a pair of handles, each handle having first and second ends, the first end of each handle being attached to the upper end of a corresponding stringer.

In some embodiments, the each stringer of the ladder further comprises an upper stringer and a lower stringer, and the ladder also has two hinges, each hinge connecting an upper stringer to a lower stringer. In some embodiments, the hinges are located near a middle of the distance between the upper and lower ends of the stringers.

In some embodiments, the stringers comprise rectangular tubing. In some embodiments, the ladder also has leg extensions. In some embodiments, the ladder also has a pair of wheels connected to the leg extensions and an axle. In some embodiments, the ladder also has adjustment holes for adjusting the position of the leg extensions. In some embodiments, the position of the leg extensions are adjusted and locked using an internal spring plunger that engages the adjustment holes. In some embodiments, the position of the leg extensions are adjusted and locked using an external spring plunger that engages the adjustment holes.

In some embodiments, the ladder also has a platform removably connected to the lower ends of the stringers. In some embodiments, the platform is pivotally connected to the leg extensions so that the platform can swing between substantially parallel and substantially perpendicular orientations with the stringers.

In some embodiments, the ladder assembly has a mounting bracket releasably attached to the second ends of the handles. In some embodiments, the ladder assembly has a connecting pin that secures a disc to the second end of the handles and a cleat receiver on the mounting bracket releasably engages the connecting pin. In some embodiments, the ladder assembly has a disc attached to the second end of the handles, and a disc receiver having a cleat bar attached to the mounting bracket, the disc releasably engaging the cleat bar. In some embodiments, the mounting bracket attaches to an automotive body or horizontal deck.

In another aspect, a method of transporting cargo from an automobile includes providing an automotive ladder previously described and loading cargo onto the ladder.

### BRIEF DESCRIPTION OF THE DRAWINGS

FIG. 1 is a side view of a ladder assembly with extension legs and wheels.

FIG. 2 is a side view of a ladder assembly with a platform and wheels in a folded configuration.

FIG. 3 is a top view of a mounting assembly with a cleat plate and cleat receivers.

FIG. 4 is a side view of a ladder assembly and mounting assembly connected to an automobile surface.

FIG. 5 is side view of the ladder assembly of FIG. 1.

FIG. 6 is a front view of the ladder assembly of FIG. 2.

FIG. 7 is a side view of a cleat plate with two disc receivers mounted thereon.

FIG. 8A is a side view of a ladder assembly showing a handle with a disc and disc opening.

FIG. 8B is a side view of a ladder assembly showing a handle with a disc and disc opening.

FIG. 9 is a side view of a ladder assembly showing a handle engaged with a mounting assembly.

FIG. 10 is a side view of an extension leg with an attached wheel.

FIG. 11 is a side view of an extension leg inserted into a ladder assembly and secured with a spring plunger.

### DETAILED DESCRIPTION

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In one aspect, an automotive ladder assembly is disclosed. The assembly includes various components including a ladder with stringers, steps, a pair of handles, and a mounting assembly for connecting the ladder's handles to a horizontal deck such as a tailgate of a vehicle.

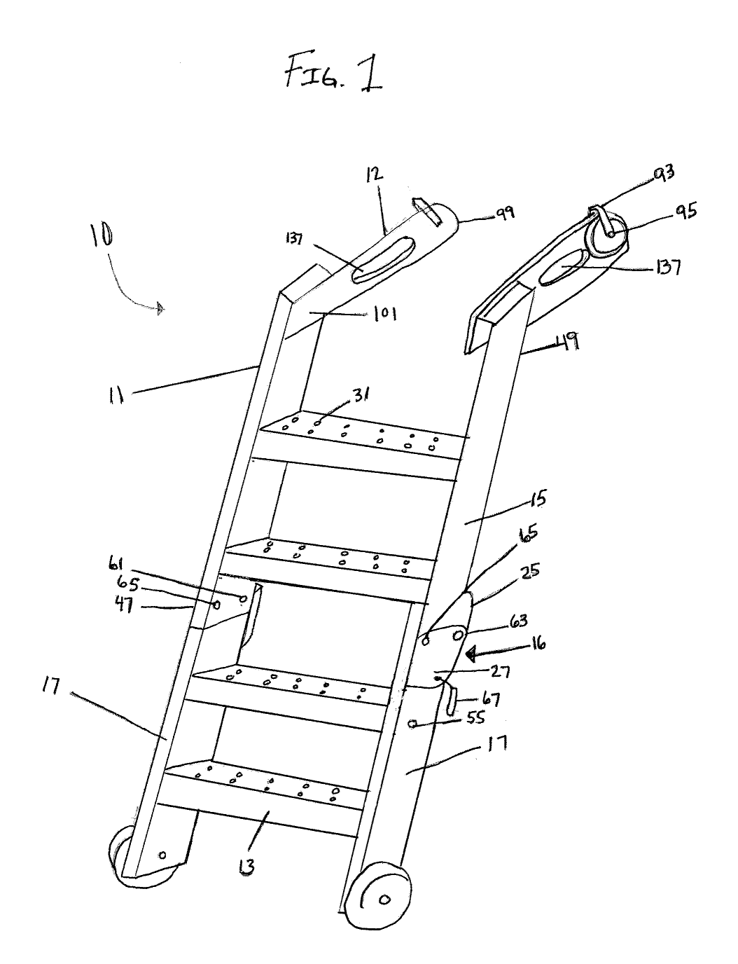

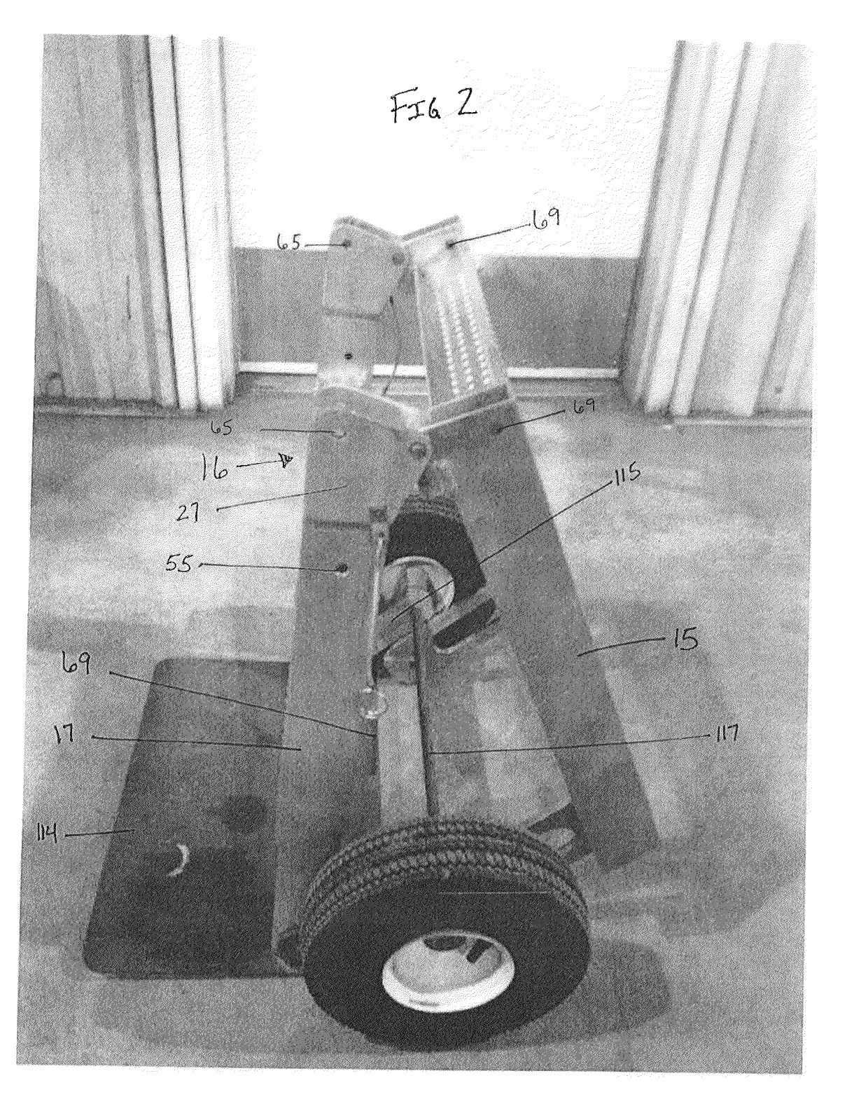

Referring to FIG. 1, there is shown an embodiment of a ladder assembly 10. The ladder assembly 10 includes a pair of parallel stringers 11. In general, the stringers 11 are substantially parallel to one another. In some embodiments, each stringer may also include an upper segment 15 and a lower segment 17. In some embodiments, the upper and lower segments can be connected through a hinging means, such as hinge assembly 16 shown in FIG. 1. The hinge assembly enables a user to fold the ladder assembly between an extended state (such as that shown in FIG. 1) and a collapsed or folded state (such as that shown in FIGS. 2 and 6). In the folded state, the stringer segments 11 form an angle of between 120 and 180 degrees.

In some embodiments, the stringers need not be substantially parallel for their entire length relative to one another. For example, the lower segment of the stringers may be wider at their base and narrow as the lower stringers connect with the upper stringers.

The hinge assembly 16 includes a hinge block 25 mounted on a rear side of a stringer 11, such as a bottom portion of an upper stringer 15. The hinge block 25 is configured to have an opening 61 to receive a hinge pin, and the hinge pin also passes through a stringer 11 providing for a pivot point in the ladder assembly. The hinge assembly 16 also includes a plate 27 which can be mounted on an upper portion of the lower stringer 17. In some embodiments, the hinge plate 27 may integral with the lower portion 17. In other embodiments, the hinge plate 27 can be welded to a lower portion of upper stringer. In some embodiments, the hinge plate 27 may be removably connected to the upper portion of the lower stringer 17. The hinge plate 27 may also include a locking opening 65 through which a hinge pin 63 or a cotter pin 67 or other fastening device may pass. When in a locked configuration, the fastening device (e.g. cotter pin 67) passes through locking opening 65 and a corresponding locking opening 69 located near the lower portion 47 of the upper stringer 15.

Optionally, one of the upper and lower portions may have a storage opening in which the fastening device may be stored. For example in FIGS. 1 and 2, storage opening 55 may receive a cotter pin 67 when the ladder is in a folded configuration.

In some embodiments, the parallel stringers 11 are continuous and incapable of folding.

The ladder assembly 10 also includes a plurality of steps (or rungs) 13 spanning between the stringers 11. The steps 13 can be perpendicular to the stringers 11 and connected, for example with a metal weld. The height of the stringers 11 and width of the steps 13 may be of varying dimensions with consideration of automobile height and width. In some embodiments such as those shown in FIGS. 1 and 2, the steps 13 are welded at their ends 30 to the stringers. In other embodiments, the parallel steps can fit into a plurality of pre-formed openings in the stringers 11.

In some embodiments, the steps 13 can be textured such as with a plurality of raised bumps or stippling 31. In some embodiments, the texture can take the form of parallel grooves, intersecting grooves, and the like. The texture serves the purpose of improving the friction between a user's shoes or gloves with the steps, thereby giving improved traction when climbing up and down the steps.

A pair of handles 12 having first ends 101 are mounted to the stringers at the upper portions 49 of the upper portions 15. The handles 12 may be manipulated by a user when removing the ladder assembly 10 from an automobile or horizontal deck (not shown). The handles may include gaps 137 that facilitate a user's gripping of the handles. The handles 12 also can connect the ladder assembly 10 to a mounting assembly 71 through discs 99 mounted on the second ends 103 of the handles 12. The discs 99 are attached to the handles with connecting pins 95 and leave a gap between the discs 99 and handles 12.

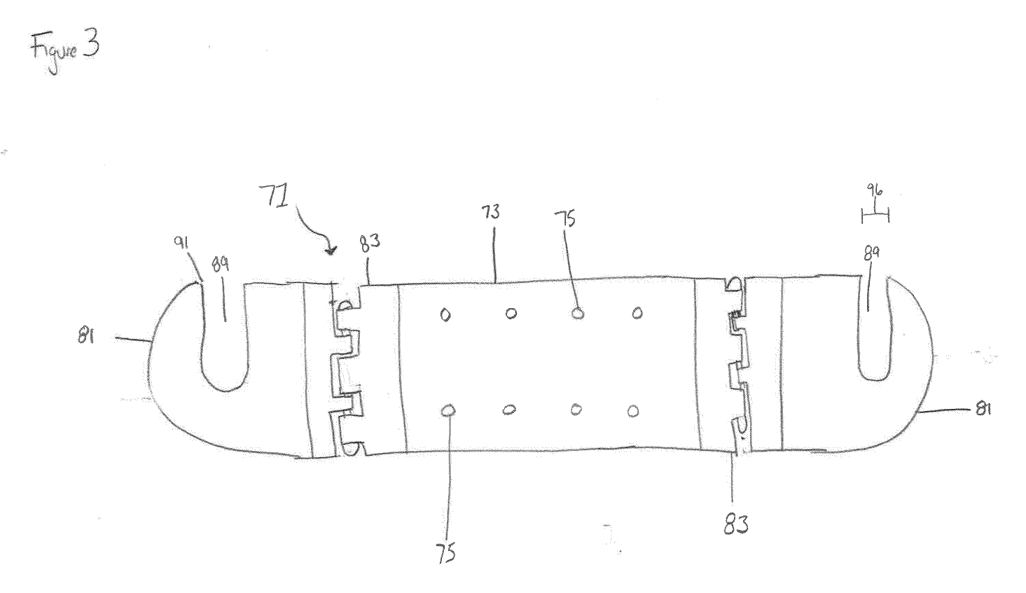

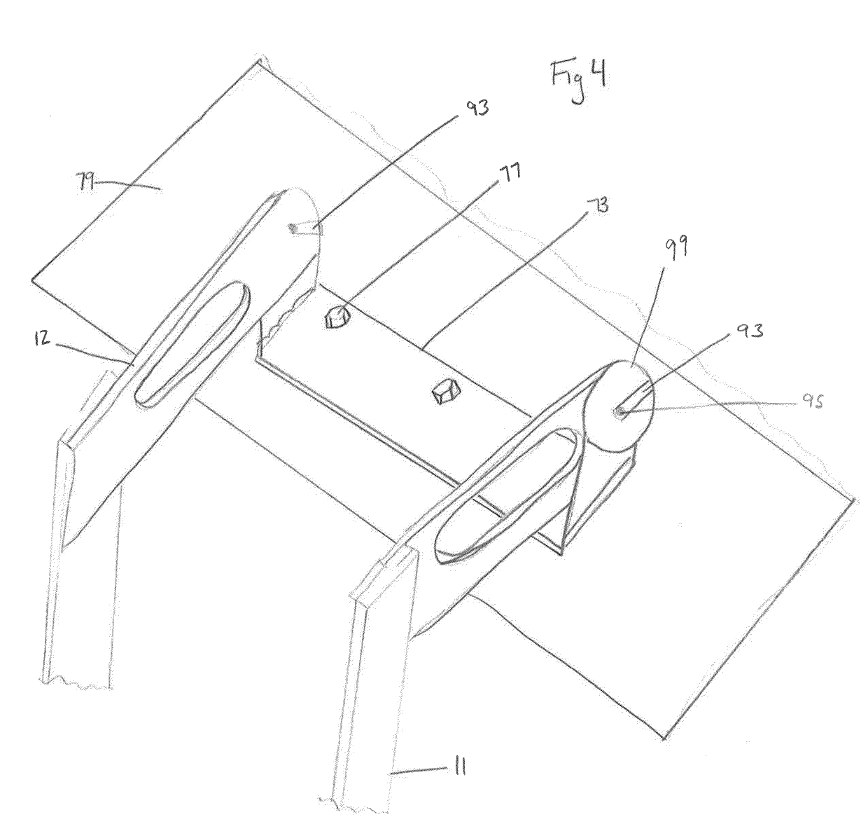

Referring now to FIGS. 3 and 4, a mounting assembly 71 for connecting the ladder to a vehicle surface is shown. The mounting assembly includes a cleat plate 73. The cleat plate includes at least one or a plurality of openings 75 through which fasteners can attach the cleat plate 73 to an automobile surface 79 such as a tailgate. Fasteners include rivets, bolts, clamps, among others. In another embodiment, the cleat plate may attach to a horizontal surface with hook and pile fasteners.

In some embodiments, the cleat plate 73 includes a pair of cleat receivers 81 which are connected to cleat plate 73. The cleat receivers 81 may be pivotally connected with hinges 83. The cleat receivers 81 include a channel 89 that extends from a first end 91 to nearly the center of the receiver 81. The channel 89 has a width 96 corresponding to the diameter of connecting pins 95 located on handles 12.

In some embodiments, handles 12 connect to the cleat plate 73 by sliding the connecting pins 95 through the channel 89 to the center of the receiver 81 and alongside discs 99. A locking strap 93 may be rotated forward about an axis of the connecting pins 95 to secure the handle connection to the plate 73.

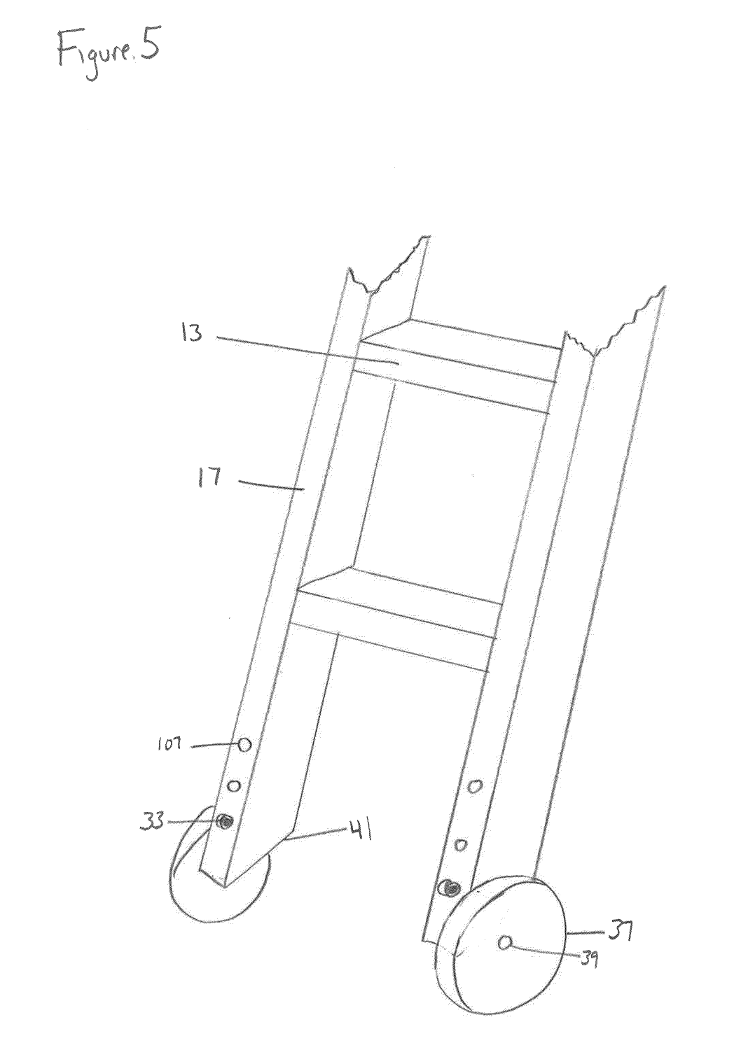

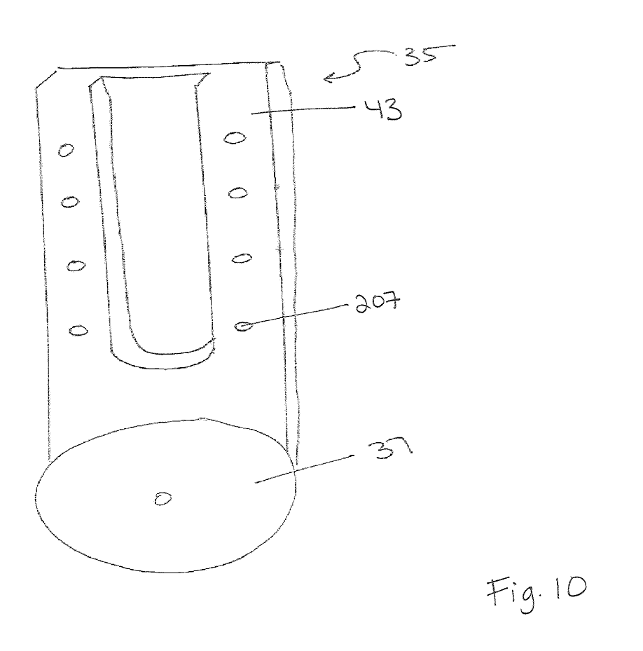

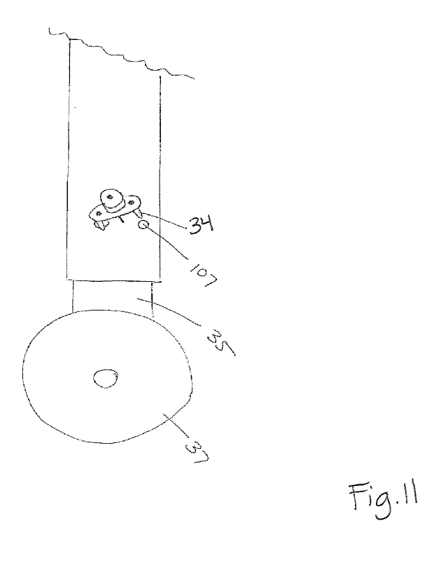

In some embodiments such as shown in FIGS. 5 and 10, the lower portions 17 may include a plurality of holes 107 for aligning with extension legs 35 that fit within the lower portions 17. The extension leg inserts may have wheels 37 (phenolic caster wheels for example) connected to a bottom end 41 of the extension leg through a wheel axle 39. An upper end 43 of the extension leg fits within the lower portion 17. The extension legs may be locked into the lower portion using, for example, an internal spring plunger 33. The spring plunger 33 may be inserted into the holes 107 and a corresponding pair of holes 207 passing through the width (or a tube) of an extension leg. The spring plunger 33 may be pushed in to facilitate height adjustment. The spring plunger 33 becomes extended each time it aligns with an appropriate hole 107.

The height of extension legs 35 may be independently adjusted such as with spring plungers 105 to hold the extension legs 35 (with or without optional wheels) at a desired height. Such options may be desirable when the ladder might abut an uneven surface. The spring plungers 105 are inserted into holes 107 in the lower portions. Other appropriate fasteners can be used.

In some embodiments such as shown in FIG. 11, an external spring plunger 34 may be inserted into holes 107 in the lower portions of stringers 11 to hold the extension leg 35 in the stringer 11.

Referring to FIGS. 2 and 6, there is shown the embodiment of FIG. 1, but with the ladder assembly 10 in a folded configuration and without connection to the mounting assembly 71. Because the lower segments of the stringers can have insertable extension legs, a wide variety of features can be added to the bottom of the ladder. As also shown in FIGS. 2 and 6, the platform and wheels make the ladder usable as a dolly or moving truck. Other suitable equipment may also be added to the ladder so long as that equipment is fitted with extension legs that fit within the stringers. As shown in FIG. 1, the extension legs can be fitted with wheels. Alternatively, extension legs can simply extend the height of the ladder for use to climb other surfaces such as a wall. In such embodiments, the extension legs may also be bridged to one another with one or more steps. Also, because the extension legs are adjustable, the ladder may be used on uneven ground surfaces.

Extendable arms may also be inserted in to the top of the stringers to provide additional grasping handles. The grasping handles can enable a user to steady themselves when the assembly is used as a ladder, or to extend the assembly when used as a dolly or hand truck.

The stringers, steps, and other components of the ladder assembly may be made from a variety of materials, including metals such as steel or aluminum, or suitable, strong polymers.

In some embodiments, the stringers can be made of rectangular tubing. In some embodiments, the stringers can be made of circular tubing.

Referring to FIGS. 2 and 6, there is shown an alternate embodiment of the ladder assembly shown in FIG. 1 where the lower ends 13 of the stringers 11 are connected to a platform assembly 131

The platform assembly includes a platform 114 situated between extension legs 113. The extension legs are receivable into the lower portions 17 of the ladder assembly. The extension legs also adjoin struts 115 which are connected to a wheel axle 117. The wheel axle is connected to a pair of wheels 119, (inflatable rubber wheels, for example).

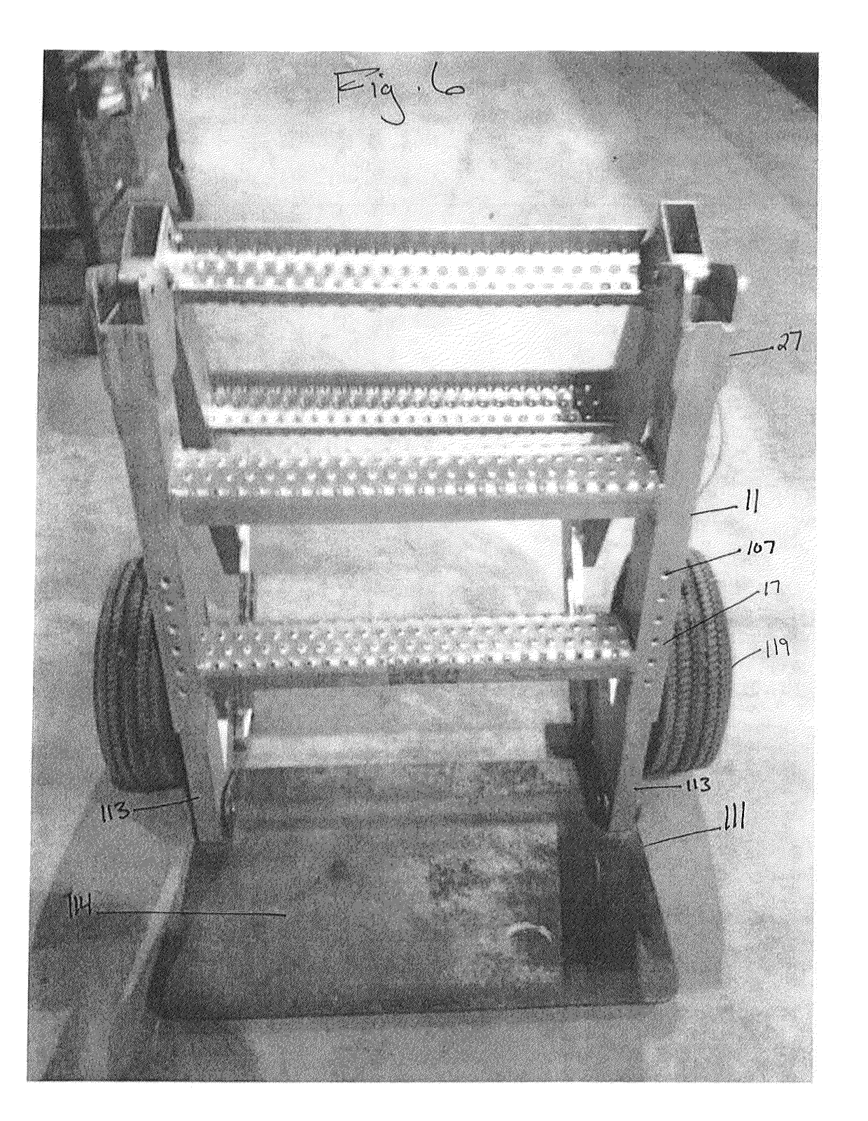

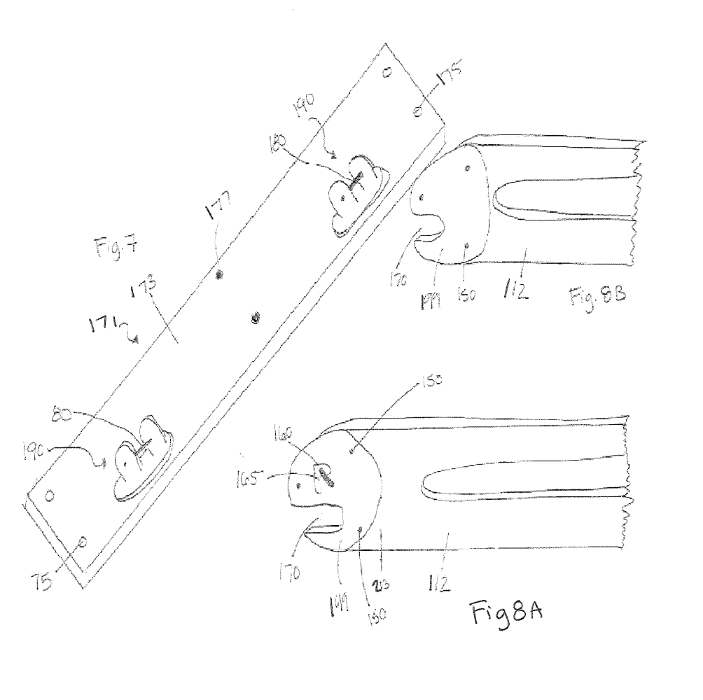

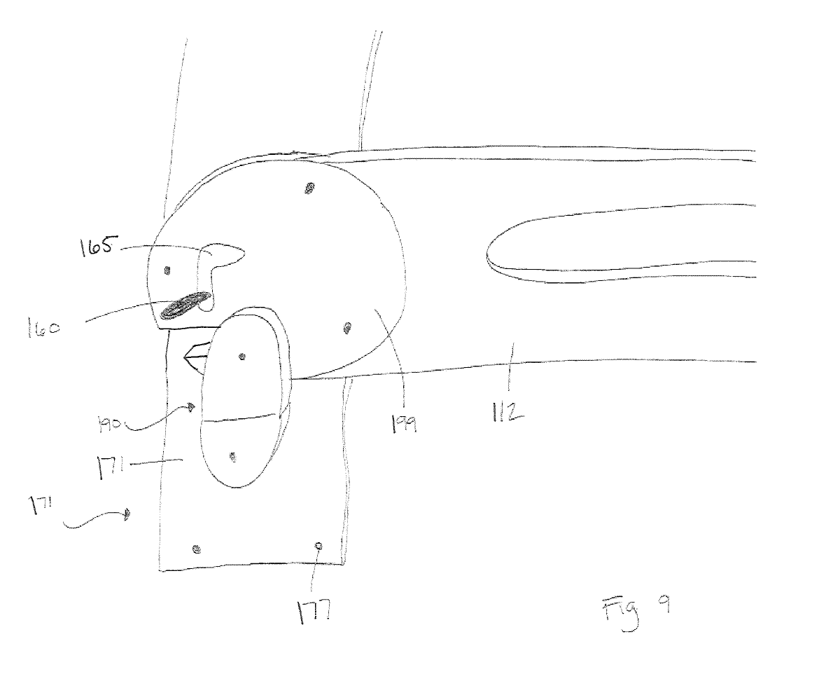

In some embodiments such as shown in FIG. 7, a cleat plate 173 has one or more openings 175 that can be connected to a vehicle surface by fasteners 177. Fastener 177 can be anything that secures the cleat plate 173 to a vehicle surface, for example a rivet, screw, nail, or pin. The cleat plate 173 has one or more disc receivers 190. Disc receiver 190 has a cleat bar 180 that is configured to receive a disc opening 170, described below. As shown in FIG. 8A and 8B, at least one disc 199 is secured to the second end 203 of handle 112 with at least one connector 150. Connector 150 can be a bolt, nail, screw, or any suitable connector capable of securing the disc 199 to the end of the handle 112. The disc 199 is shaped to have a disc opening 170 that is configured to engage mounting assembly 171. The disc opening 170 may be any suitable shape that can engage the mounting assembly 171, for example an oblong shape. The disc 199 has a locking bar 160 that is generally T-shaped, although it can be any shape that can secure the disc opening 170 to the mounting assembly 171 as described below. The locking bar 160 is configured to be in an engaging position—where the disc opening 170 is secured to the mounting assembly 171 as seen in FIG. 9, and a releasing position—where the locking bar 160 does not secure the disc opening 170 to the mounting assembly 171. A user moves locking bar 160 through a locking bar channel 165 to move the locking bar 160 from an engaging position to a releasing position.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. The embodiments described below may be more fully understood by reading the following description in conjunction with the drawings.

1. A multi-function automotive ladder, comprising:
a frame having two stringers, each stringer having upper and lower ends;
a plurality of steps extending between the stringers;
a pair of handles, each handle having first and second ends, the first end of each handle being attached to the upper end of a corresponding stringer.

2. The ladder assembly of claim 1, wherein each stringer further comprises an upper stringer and a lower stringer;
the ladder further comprising two hinges, each hinge connecting an upper stringer to a lower stringer.

3. The ladder assembly of claim 2, wherein the hinges are located near a middle of the distance between the upper and lower ends of the stringers.

4. The ladder assembly of claim 1, wherein the stringers comprise rectangular tubing.

5. The ladder assembly of claim 1, further comprising leg extensions.

6. The ladder assembly of claim 5, further comprising a pair of wheels connected to the leg extensions and an axle.

7. The ladder assembly of claim 5, further comprising adjustment holes for adjusting the position of the leg extensions.

8. The ladder assembly of claim 7, wherein the position of the leg extensions are adjusted and locked using an internal spring plunger that engages the adjustment holes.

9. The ladder assembly of claim 7, wherein the position of the leg extensions are adjusted and locked using an external spring plunger that engages the adjustment holes.

10. The ladder assembly of claim 1, further comprising a platform removably connected to the lower ends of the stringers.

11. The ladder assembly of any one of claims 10, wherein the platform is pivotally connected to the leg extensions so that the platform can swing between substantially parallel and substantially perpendicular orientations with the stringers.

12. The ladder assembly of claim 1, further comprising a mounting bracket releasably attached to the second ends of the handles.

13. The ladder assembly of claim 12, further comprising:
a connecting pin that secures a disc to the second end of the handles; and
a cleat receiver on the mounting bracket releasably engages the connecting pin.

14. The ladder of claim 12, further comprising:
a disc attached to the second end of the handles; and
a disc receiver having a cleat bar attached to the mounting bracket;
the disc releasably engaging the cleat bar.

15. The ladder assembly of claim 1, wherein the mounting bracket attaches to an automotive body or horizontal deck.

16. A method of transporting cargo from an automobile comprising providing an automotive ladder of claim 10, and loading cargo onto the ladder.

17. A method of transporting cargo from an automobile comprising providing an automotive ladder of claim 11, and loading cargo onto the ladder.
